(19) United States
(12) Patent Application Publication
(10) Pub. No.: US 2026/0304505 A1
(43) Pub. Date: Oct. 1, 2026

(54) ADAPTIVE NETWORK SLICE AREA OF SERVICE

(71) Applicant: InterDigital Patent Holdings, Inc., Wilmington, DE (US)

(72) Inventors: Ulises Olvera-Hernandez, Saint-Lazare (CA); Taimoor Abbas, Sainte-Julie (CA); Anuj Sethi, Ottawa (CA); Michael Starsinic, Newtown, PA (US); Saad Ahmad, Montreal (CA); Samir Ferdi, Kirkland (CA); Achref Methenni, Montreal (CA)

(73) Assignee: InterDigital Patent Holdings, Inc., Wilmington, DE (US)

(21) Appl. No.: 19/096,400

(22) Filed: Mar. 31, 2025

(51) Int. Cl. H04W 76/10; H04L 65/1016; H04W 48/18; H04W 60/04

(52) U.S. Cl. CPC H04W 76/10; H04L 65/1016; H04W 48/18; H04W 60/04

(57) ABSTRACT

Network slice-free procedures to request data connectivity resources by a WTRU (Wireless Transmit Receive Unit) are described. Methods include transmitting, to a network, a first non-access stratum (NAS) message including an indication of services the WTRU supports; receiving a second NAS message including a temporary address of an SMF the WTRU should use to establish data connectivity; initializing a timer based on the second NAS message; and triggering a registration procedure upon expiration of the timer.

### BACKGROUND

Network slicing is a mandatory feature of the 5GS, i.e., there is at least one network slice in the network and every wireless transmit receive unit (WTRU) uses at least one network slice. A network slice is a logical network that provides specific network capabilities and network characteristics. In some use cases a WTRU can just use a single network slice, and one or more packet data unit (PDU) sessions (to different data network names (DNNs)) in the network slice to support different services as needed. In some example systems, if a network slice is not homogenously available in an entire registration area, the network slice can only be used if the WTRU supports partially allowed network slice selection assistance information (NSSAI), forcing the WTRU to have awareness of a network side deployment.

### SUMMARY

In embodiments, a method is performed by a wireless transmit/receive unit (WTRU), the method including: transmitting, to a network, a first non-access stratum (NAS) message including an indication of services the WTRU supports; receiving a second NAS message including a temporary address of an SMF the WTRU should use to establish data connectivity; initializing a timer based on the second NAS message; and triggering a registration procedure upon expiration of the timer. Additionally/alternatively, the method may include wherein the first NAS message includes an indication that the WTRU supports including at least one of IP multimedia core network subsystem (IMS) calling, streaming services or internet of things (IoT) traffic; and a service module profile, indicating cellular features the WTRU supports. Additionally/alternatively, the method may include wherein the first NAS message includes an indication that the WTRU supports time sensitive communications, or artificial intelligence markup language (AIML)-based cellular functional logic. Additionally/alternatively, the registration procedure includes: transmitting, to the network, a third NAS message including a data connectivity request and indicating that support for traffic categories in a specific data network is required; and receiving, from the network, a fourth NAS message indicating whether the data connectivity request is granted. Additionally/alternatively, the method may include wherein the third NAS message includes an indication that the traffic categories either require network support on an entire registration area or require network support on predetermined locations at predetermined times. Additionally/alternatively, the method may include wherein the fourth NAS message includes an indication that the traffic categories are supported on an entire registration area or require network on predetermined locations at predetermined times. Additionally/alternatively, the method may include wherein the fourth NAS message includes an indication that the traffic categories are supported according to a mapped route selection descriptor.

In embodiments a method is performed in a resource management facility (RMF) in a cellular network, the method including: receiving, from a wireless transmit/receive unit (WTRU), a non-access stratum (NAS) message indicating services supported by the WTRU; transmitting, to a UDR/UDM (Unified Data Management function/Unified Data Repository function), a first message indicating the services the WTRU supports; receiving, from the UDR/UDM, a second message indicating a single network slice selection assistance information (S-NSSAI) associated with a service capability or a service function module of the WTRU; transmitting, to a network slice selection function (NSSF) or a network repository function (NRF), a third message indicating the S-NSSAI associated the services supported by the WTRU; receiving, from the NSSF or NRF, a session management function (SMF) identifier (ID) or SMF instance ID of an SMF associated to the services supported by the WTRU; generating a temporary SMF identifier; and transmitting the temporary SMF identifier and a configuration update to the WTRU. Additionally/alternatively, the method may include wherein the configuration update includes an indication of allowed services and temporal and spatial validity restrictions. Additionally/alternatively, the method may include wherein the configuration update includes an indication of allowed services and conditions for the allowed services. Additionally/alternatively, the method may include wherein the first NAS message includes an indication that the WTRU supports: IP multimedia core network subsystem (IMS) calling, streaming services or internet of things (IoT) traffic; and a service module profile, indicating cellular features the WTRU is capable of supporting. Additionally/alternatively, the method may include wherein the first message indicates a service capability or a service function module. Additionally/alternatively, the method may include wherein the temporary SMF identifier is valid within a registration area allocated to the WTRU. Additionally/alternatively, the method may include wherein the temporary SMF identifier is valid within a specific area of service. Additionally/alternatively, the method may include transmitting a validity time for the temporary SMF identifier to a base station.

In embodiments, a wireless transmit receive unit (WTRU) may include: a processor and a transceiver, wherein the processor and the transceiver are configured to: transmit, to a network, a first non-access stratum (NAS) message including an indication of services the WTRU supports; receive a second NAS message including a temporary address of an SMF the WTRU should use to establish data connectivity; initialize a timer based on the second NAS message; and trigger a registration procedure upon expiration of the timer. Additionally/alternatively, the WTRU may include wherein the first NAS message includes an indication that the WTRU supports at least one of: IP multimedia core network subsystem (IMS) calling, streaming services or internet of things (IoT) traffic; and a service module profile, indicating cellular features the WTRU supporting supports. Additionally/alternatively, the WTRU may include wherein the first NAS message includes an indication that the WTRU supports time sensitive communications, or artificial intelligence markup language (AIML)-based cellular functional logic. Additionally/alternatively, the method may include wherein the registration procedure includes: transmitting, to the network, a third NAS message including a data connectivity request and indicating that support for traffic categories in a specific data network is required; and receiving, from the network, a fourth NAS message indicating whether the data connectivity request is granted. Additionally/alternatively, the WTRU may include wherein the third NAS message includes an indication that the traffic categories either require network support on an entire registration area or require network support on predetermined locations at predetermined times.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a diagram showing WTRU use of URSP rules;

FIG. 3 a further diagram showing WTRU use of URSP rules;

FIG. 4 is a diagram showing availability of network slices in a registration area;

FIG. 5 is an example procedure for a WTRU to determine NAS layer parameter values;

FIG. 6 is a diagram of an example network slice free route selection;

FIG. 7 is a diagram of a further example of network slice free route selection;

FIG. 8 is a system flow diagram for an example process for a network slice free connectivity request;

FIG. 9 is a flow diagram for an example procedure performed by a WTRU; and

FIG. 10 is a flow diagram for an example procedure performed by a resource management facility.

### DETAILED DESCRIPTION

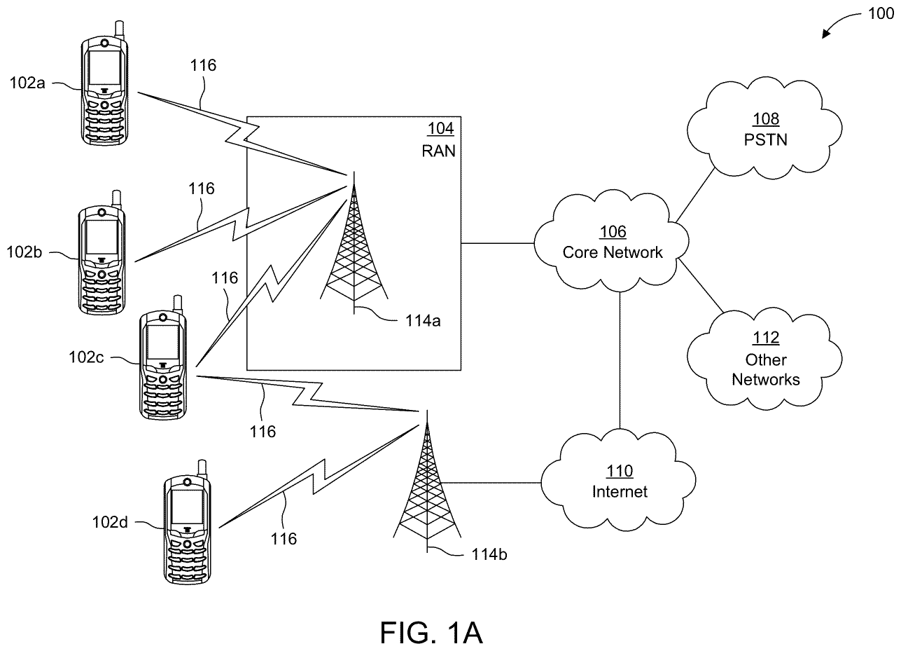

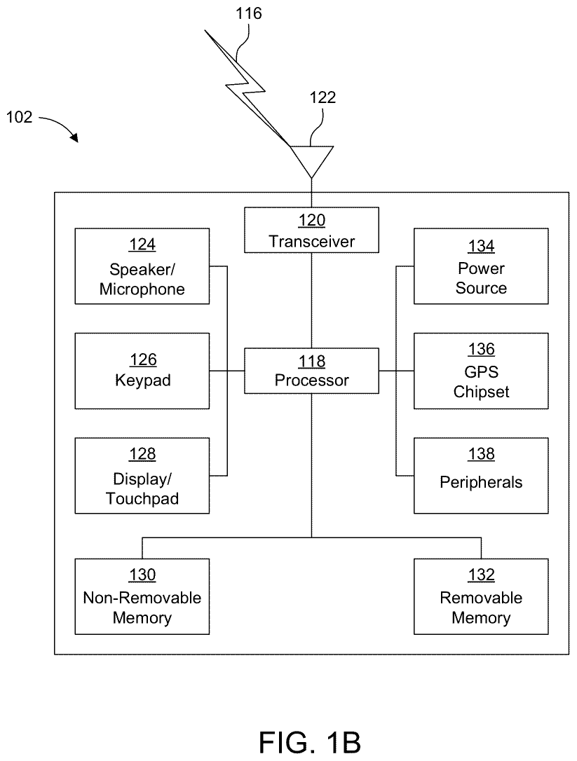

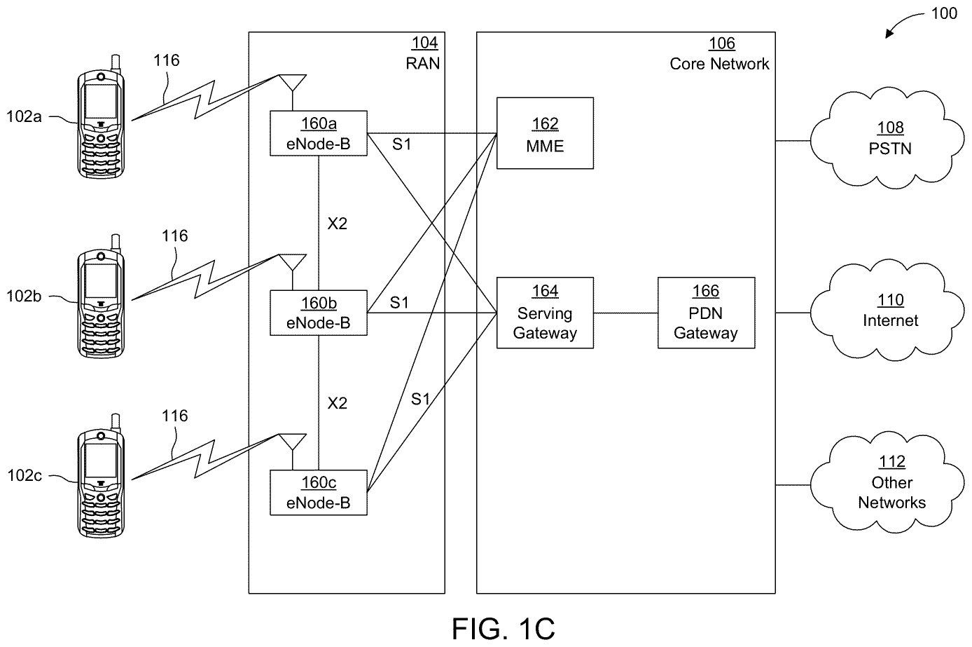

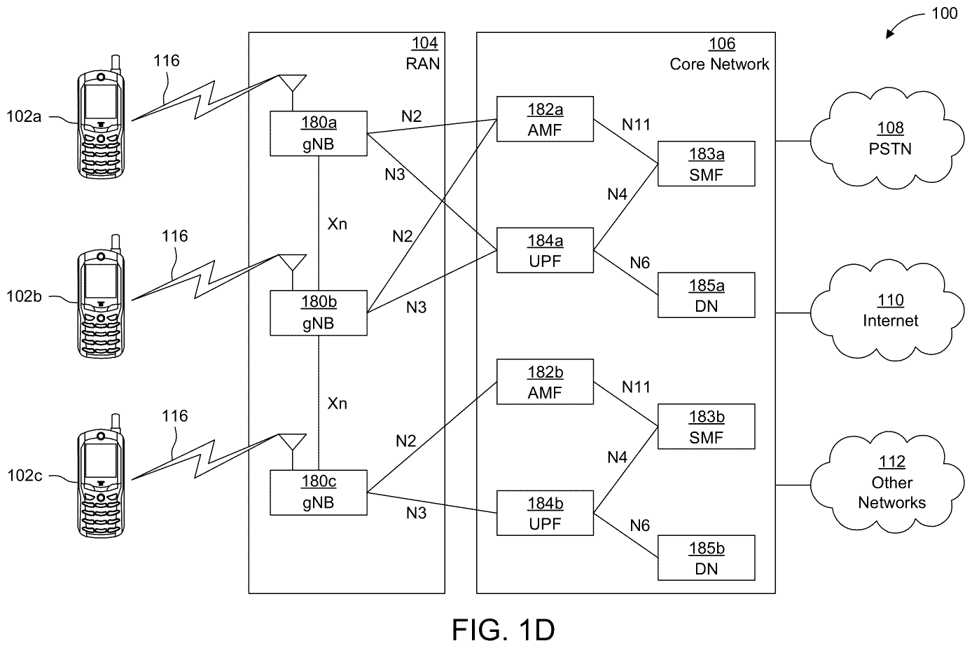

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (for example, remote surgery), an industrial device and applications (for example, a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (for example, radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (for example, an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (for example, for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (for example, WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (for example, the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (for example, the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (for example, multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (for example, a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (for example, nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (for example, longitude and latitude) regarding the current location of the WTRU 102. In addition to, or in lieu of, the information from the GPS chipset 136, the WTRU 102 may receive location information over the air interface 116 from a base station (for example, base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (for example, associated with particular subframes for both the UL (for example, for transmission) and DL (for example, for reception) may be concurrent and/or simultaneous. The full duplex radio may include an interference management unit to reduce and or substantially eliminate self-interference via either hardware (for example, a choke) or signal processing via a processor (for example, a separate processor (not shown) or via processor 118). In an embodiment, the WTRU 102 may include a half-duplex radio for which transmission and reception of some or all of the signals (for example, associated with particular subframes for either the UL (for example, for transmission) or the DL (for example, for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (for example, an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (for example, temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (for example, directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (for example, all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (for example, 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (for example, every STA), including the AP, may sense the primary channel. If the primary channel is sensed/detected and/or determined to be busy by a particular STA, the particular STA may back off. One STA (for example, only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (for example, only support for) certain and/or limited bandwidths. The MTC devices may include a battery with a battery life above a threshold (for example, to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (for example, MTC type devices) that support (for example, only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (for example, containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (for example for example, such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (for example, handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184a, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (for example, an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (for example, testing) wired and/or wireless communication network in order to implement testing of one or more components. The one or more emulation devices may be test equipment. Direct RF coupling and/or wireless communications via RF circuitry (for example, which may include one or more antennas) may be used by the emulation devices to transmit and/or receive data.

The following terms are used as defined herein. A network slice instance is defined within a public land mobile network (PLMN) or within a stand-alone non-public network (SNPN) and may include: the Core Network Control Plane and User Plane Network Functions of the Access Network, for example, 3GPP NG-RAN or Non-3GPP N3IWF/TNGF. WTRU Route Selection Policy rule (URSP), is used by the WTRU to determine how to route outgoing traffic. Traffic can be routed to an established PDU Session, can be offloaded to non-3GPP access outside a PDU Session, or can trigger the establishment of a new PDU Session. Traffic categories are defined to accommodate connectivity requirements that are shared among different applications traffic. Herein, the terms traffic categories and connection capabilities are used interchangeably. A route selection descriptor is used by a WTRU in a matching URSP rule to determine PDU Session connectivity parameters such as S-NSSAI(s), DNN(s), and PDU Session Type. These parameters enable the WTRU to determine if the user traffic data can be forwarded through an already established PDU Session or if there is a need to trigger the establishment of a new PDU Session.

URSP rules are described herein. URSP is a 5G feature enabling a mobile network operator (MNO) to use MNO controlled rules, which instruct the a WTRU to map matching uplink application traffic (user data traffic) to PDU session connectivity parameters or to route the application traffic outside of a PDU Session, for example, to offload to a WLAN connection. The WTRU may use a set of parameters, for example, S-NSSAI and Data Network Name (DNN), to establish a PDU Session. URSP rules can be provisioned on the UE or provided by a network to the UE.

While it is not mandatory for a WTRU to support URSP, in scenarios, the support of URSP may be mandatory for WTRUs supporting IMS voice over 5GS.

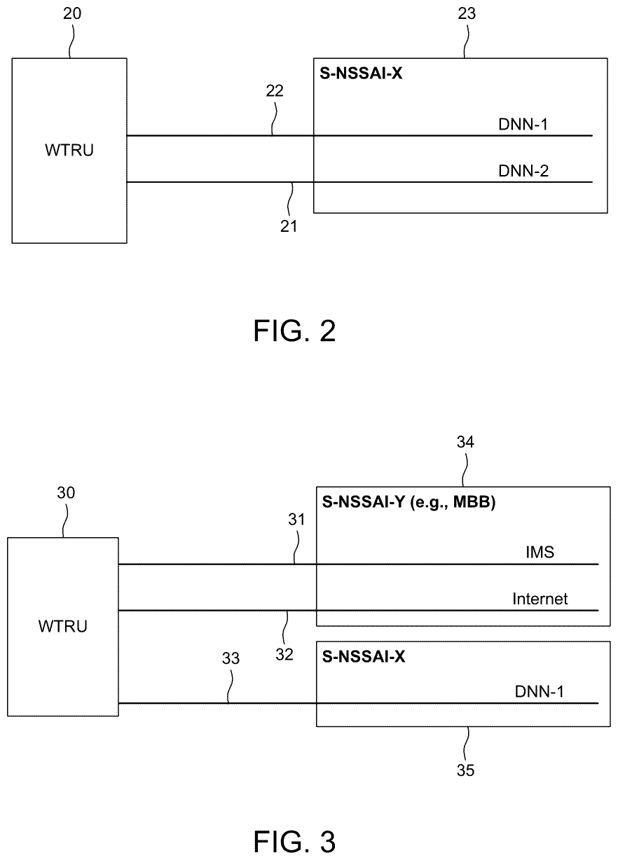

FIGS. 2 and 3 illustrate how a WTRU (20, 30) may use URSP rules to funnel user application traffic from an application to a PDU session matching a URSP rule and directing this traffic to the matching Route Selection Descriptor 33, 34, 35 (i.e., the PDU Session supporting the RSD). References 21 and 22, represent PDU Sessions associated with network slice represented by a Single-Network Slice Selection Assistance Information-X (S-NSSAI-X) 620 which enables access to Data Network Name-1 (DNN-1) and DNN-2, respectively. References 31 and 32 represent PDU Sessions associated with S-NSSAI-Y 34 enabling access to IMS services and Internet Services respectively. Likewise, 33 represent PDU Sessions associated with S-NSSAI-X 35 which enables access to Data Network Name-1 (DNN-1). The PCF for the WTRU may adjust the URSP rules when needed, based on the notified URSP rule enforcement information, which may include WTRU reported connection capabilities if available, PDU Session parameters if available, and detected application event if applicable. The policy control function (PCF) for the PDU Session may generate policy charging control (PCC) rules under consideration of the traffic descriptor corresponding to the WTRU reported connection capabilities

When a WTRU requests access to a cellular network, it may be required to provide a network slice selection, or else, the cellular system will allocate network slice for it. In addition, these network slices always include at least an access and mobility management function (AMF), and these AMF can simultaneously belong to other network slices, not necessarily including the same set of network functions (NFs). This means that no network slices can be built without an AMF.

The following issues are addressed herein:
a) decoupling system logic that is wrapped or bound by an existing network slice construct without impacting system performance and simplifying system operation;
b) decoupling an AMF from network slices where other network functions (for example the SMF) are included;
c) decoupling registration or paging functions, managed by MM logic, from data connectivity logic, for example independently allocating AMF and SMF, or AMF and any other NF independently to network slices, without requiring access to an AMF, i.e., defining network slices without including an AMF in the network slice;
d) simplifying procedures that require WTRU awareness of network slice area of service and other special validity conditions;
e) making NW slice allocation agnostic to slice/service type;
f) NW allocation of service regions rather than network slices;
g) providing services in system regions (for example: cells, TAs, RAs) where network resources are not available;
h) managing service areas without impacting the balance between system registration and paging;
i) allocating service regions based on requirements of the service; and
j) enabling WTRUs to use service availability information in a RA to select an available TA from a list in the RA.

The complexity of network slicing specific WTRU procedures has significantly increased with the introduction of Network Slice Area of Service and other special validity conditions, for example, existing network slice procedures require WTRU awareness of the availability of network slices in a particular location, for example, a particular cell, or Tracking Area (TA). This requirement can make WTRU network selection procedures unnecessarily complicated, as it requires the WTRU to know whether Network Slices are available in the entire Registration Area (RA), or just in certain TAs or certain cells within the RA.

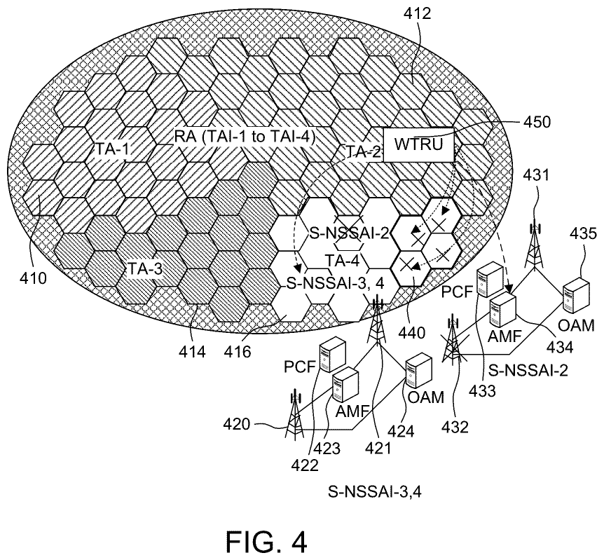

As shown in the example in FIG. 4 the constraint that a WRTU 450 knows whether network slices are available in an entire RA or just in certain TAs or certain cells within the RA can cause conditions where network slices cannot be delivered across all TAs (410, 412, 414, 416) of a RA, i.e., the WTRU 450 needs to be aware of the availability of Network Slices in all four Tracking Areas. FIG. 4 shows network slices NSSAI 3 and 4 implemented by gNBs 420 and 421, AMF 423, PCF 422 and operations and management (OAM) 424. Network slices NSSAI 2 implemented by gNBs 431, 432, AMF 434, PCF 433 and OAM 435. In FIG. 4 in, TA-4 416, the WTRU cannot use S-NSSAI-2 in TA-4, because there are no RAN resources in the cells represented by the crosses 440, even if the AMF 434 is available in the cells represented with the dashed arrow going between the WTRU 450 and the AMF 434 in S-NSSAI-2.

Since S-NSSAI-3 and S-NSSAI-4 are available across the RA, the WTRU only can use those two NW slices.

In some systems, a WTRU may be able to access a network slice that may be partially allowed in a RA or rejected partially in a RA. The WTRU needs to be aware of this situation. In some systems the WTRU may obtain one or more rejected S-NSSAIs with cause and validity of rejection, for example, some S-NSSAIs may be temporarily out of commission, and temporal validity conditions, such a time or a location, may be provided. An S-NSSAI may be rejected for the entire PLMN, for the current Registration area (RA) only, or partially in the current RA as depicted in FIG. 4 where a specific TA is not supported for a particular S-NSSAI.

Embodiments described herein simplify procedures that require WTRU awareness of network slice area of service, slice and service type, validity regions and conditions. Embodiments described herein enable network slice availability that is homogenous across the registration area of a WRTU.

In embodiments, a network may allocate service regions for a WTRU based on traffic categories, rather than the required network slices. In an embodiment, the network allocates a service area such that it maps over the whole registration area for the WTRU, hence minimizing the registration area update requirements to access allowed network slices. In another embodiment, the service regions are allocated dynamically to adopt to the network conditions and load.

In embodiments, a WTRU may derive traffic categories based on network data connectivity requests from an upper layer, for example, a request for data connectivity from an application or from the WTRU operating system. The WTRU may derive appropriate Traffic Category and DNN combinations that satisfy the connectivity request, for example, the WTRU may use an application identifier received from an upper layer and map it to a DNN/traffic category combination.

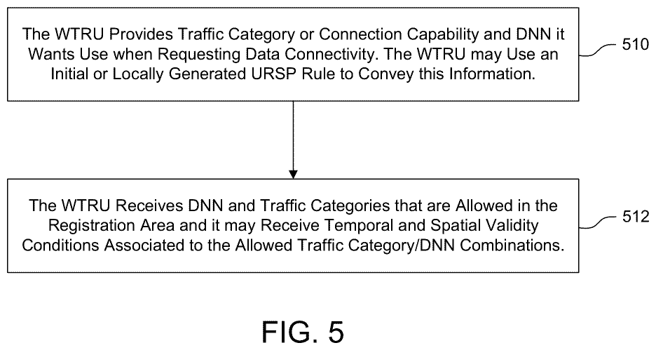

In further embodiments, a WTRU may associate upper layer connectivity requirements to a quality of service (QoS) parameters/DNN combination. In further embodiments, a WTRU may store a default URSP rule that may be used to request traffic categories associated to a DNN. In further embodiments, a default URSP rule may be preconfigured, for example, by the MNO. In embodiments, the WTRU may use this default URSP rule when requesting data connectivity from the network, for example, when requesting the establishment of a PDU session. An example of this process is shown in FIG. 5. At 510 the WTRU provides traffic category or connection capability and a DNN it wants to use when requesting data connectivity. The WTRU may use an initial or locally generated URSP rule to convey this information. At 512, the WTRU receives DNN and traffic categories that are allowed in the registration area and the WTRU may receive temporal and spatial validity conditions associated to the allowed traffic category/DNN combinations.

Embodiments for traffic category-based resource allocation are described herein. Embodiments are further described enabling a WTRU to convey to the network user application requirements for data connectivity services.

In embodiments an API that is implemented at the WTRU's operating system may support network connectivity requests from applications to gain access to any of the traffic categories supported by the WTRU's operating system. The API may be able to enable applications to provide additional information, such as DNN, connection capabilities, destination full quality domain name (FQDN), or non-IP traffic descriptor component types.

In embodiments the WTRU is enabled to request the establishment of data connectivity services, for example establishment of a PDU session, without the need to specify network slicing information, or without the need for the WTRU to be aware of the network slicing as a whole, to satisfy the WTRU request. Instead, the WTRU only has to specify the traffic category and the DNN, and, in embodiments, the WTRU may also indicate whether the traffic category and DNN need to be available throughout the entire registration area, or whether alternative traffic categories and DNN combinations may be used.

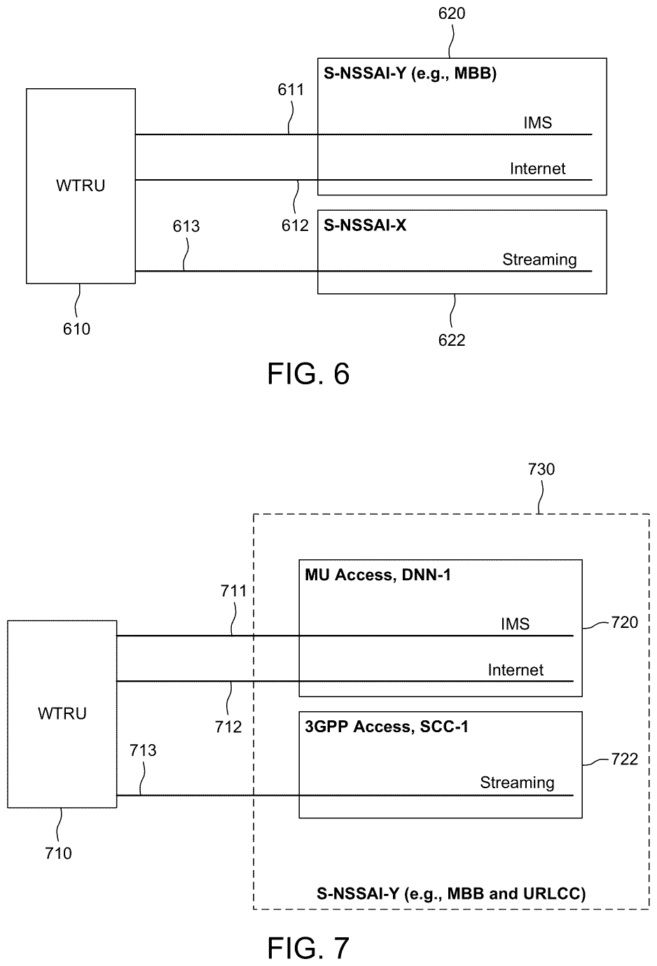

The embodiments described herein include the following: a) network-slice-free system access and registration, including access context and mobility montext updates, enabling the WTRU to gain access to a registration area where services, for example, data connectivity, may be provided, and b) data connectivity procedures that enable the WTRU to request data connectivity resources that are tailored for specific traffic and data networks and that may or may not be available through the entire registration area. As shown in FIGS. 6 and 7, in these embodiments, the WTRU does not need to be aware of the network slice, as network resources, which are MNO concerned, since the MNO is in control of how network resources are deployed and used, are allocated by the network, without required knowledge in the WTRU as to how this is done. In both scenarios described above, the WTRU only needs to provide service capabilities both physical and logical, such as hardware and software capabilities, and a description of the required services the WTRU needs to have access to, providing a traffic categories/DNN combination.

FIGS. 6 and 7 illustrate examples of the WTRU gaining access to network resources, providing mobility and reachability, as well as data connectivity services, without the need for the WTRU to be aware of the specific network resources, for example, the specific network slices, that are required to satisfy the needs of the service the user is requesting. References 611, 612, 613, represent PDU Sessions associated with S-NSSAI-Y 620 and S-NSSAI-X 622 respectively, while 711, 712 and 713 represent PDU Sessions associated with Traffic Descriptor Multi Access, DNN-1 720 and 3GPP Access, SCC-1 722, respectively.

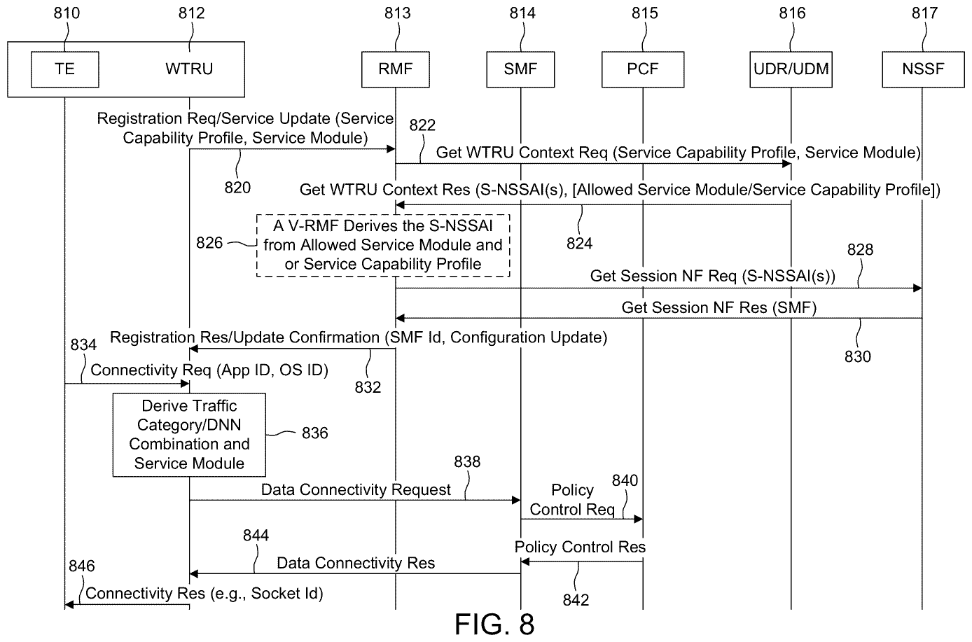

FIG. 8 is a signal flow diagram of an example process in a system comprising a WTRU 812, a registration management function (RMF) 813, an SMF 814, a PCF 815, a UDR/UDM 816 and an NSSF 817. In embodiments, the WTRU 812 may include terminal equipment (TE) 810, which may be an application running on the WTRU.

In embodiments, and with reference to FIG. 8, at 820, the WTRU registers to the network, for example, through an RMF 813 using a service capability profile. The service capability profile indicates WTRU capabilities related to services the WTRU hardware may support, for example, whether the WTRU supports IMS calling, streaming services or internet of things (IoT) traffic and a service module profile, indicating the cellular features the WTRU supports, which in embodiments is through a software module map. These services are generic, and they are not related to any particular higher layer application, they rather relate to the WTRU capability to support different types of traffic. In embodiments, an already-registered WTRU may use a service update process, for example, issuing a service update message, for example, during a mobility event to register to a new registration area, or to request resources for services that are not available in a previously accessed registration area. In embodiments, the initial registration procedure may require authentication mechanisms.

At 822, the RMF, which in embodiments have some of 5G AMF functionalities, uses the service capability profile to fetch network slices that can satisfy the services indicated by the WTRU in the service capability profile. A MNO controlled profile may also be stored in the subscriber record in the UDM/UDR, with default services, in cases where the WTRU sends an empty service capability profile, or it may be MNO-populated with MNO specific service capability for this subscriber. In embodiments, the RMF 813 may explicitly indicate subscribed S-NSSAI for the WTRU, with the given service capability profile needs to be extracted, for example, for a mobility registration.

At 824, the UDR/UDM provides the subscribed S-NSSAI that matches the WTRU service capabilities. The S-NSSAI in the subscriber record are independent from the WTRU service capabilities. For example, switching a universal integrated circuit card (UICC) to a less capable WTRU may result in a different S-NSSAI selection. In embodiments, the UDR/UDM 816 may also provide temporal and spatial validity conditions for when and where the services can be used or be available in the network. For roaming cases 826, the UDM/UDR 816 does not provide the subscribed S-NSSAI, rather it sends the allowed MON-authorized services. The V-RMF then selects the appropriate Network Slice at 828.

At 828, the RMF 816 uses the S-NSSAI obtained from the UDR/UDM 816 to request from the NSSF 817 an SMF 814 to handle the initial data connectivity request. The RMF may also provide WTRU location (for example, TA-ID). For roaming cases, the visiting RMF (V-RMF) uses the allowed, MON-authorized, service module/service capability profile as the S-NSSAI allocation is entirely managed by the visiting PLMN (V-PLMN). Thus, based on service module/service capability profile, the V-RMF then selects the appropriate network slice. In embodiments, mapping of service module/service capability profile to network slices may also be governed by a service level agreement (SLA).

Alternatively, for both roaming and non-roaming cases, the mapping of Service Module/Service Capability Profile to network slices may be handled at the NSSF, in this case, the UDR/UDM in the Non-roaming case (between Step 2 and Step 3), or the V-RMF in the Roaming case, (at Step 3b) may request a Service Module/Service Capability Profile to Network Slices resolution operation from the NSSF in the home PLMN (HPLM). The V-RMF may discover the NSSF via NRF using an HPLMN ID. The NSSF may provide the requested parameters to the V-RMF based on the service level agreements or default parameters in case no SLA exists between the VPLMN and HPLMN. This operation is not shown in the figure for simplicity.

At 830, the NSSF 817 selects an SMF 814, for example, based on the S-NSSAI provided by the RMF 813 and, in embodiments, time and spatial validity conditions. In embodiments, temporal or spatial validity conditions may be configured in the UDM/UDR 816 by the MNO.

At 832, the RMF 813 generates a temporary NF ID, for example, using the NF instance ID, and S-NSSAI ID, and a randomly generated number to construct a temporary ID (for example, a temporary SMF ID). In embodiments the temporary ID is associated with an area of service (AoS). In embodiments, the temp NF ID may be valid within the RA area allocated to the WTRU, or just a specific AoS. When the RMF sends the Initial Registration Response message through the gNB, it may provide the temporary NF ID to the gNB and associated fully qualified domain name (FQDN) or NF address, and a validity time. In embodiments, the validity time may be based on the validity condition provided by the NSSF at 830. In embodiments, the RMF may provide this information in the N2 message or equivalent SBI service operation. In embodiments, the RAN (not shown in FIG. 8) may temporarily store this value, till the core network clears it or validity time expires. In embodiments, at a later stage, when the WTRU needs to establish data connectivity or to contact a location management function, the temp NF ID may be used by the RAN node to route messages to relevant NFs, for example, to an SMF or LMF.

In further embodiments, in cases where a PDU Session is already established, the NF ID may be routed, for example, using IP routing mechanisms, if the connection between the WTRU and a network function security proxy is available and it is secure. If no PDU session is established, the RMF may request the establishment of a PDU Session, specifically intended for WTRU-NF communications, for example, to transfer NAS messages, or data collection.

At 834, an application 810 may request data connectivity from the WTRU 812, and it may provide application ID and operating system ID.

At 836, the WTRU 812 may, based on the application ID and operating system ID, derive a traffic category/DNN combination and an associated spatial and temporal validity condition.

At 838, the WTRU 812 may request data connectivity using the temp SMF ID allocated to the current RA, and provide the traffic category/DNN combination.

At 840, the SMF 814 requests SM policies from a PCF 815 on the same S-NSSAI. The SMF may derive the S-NSSAI from the provided temporary SMF ID.

At 842, the PCF 815 selects URSP rules to enable mapping of traffic categories and DNN combinations to the PDU session supporting these traffic categories. In embodiments, using temporal and spatial validity conditions the SMF delivers selected URSP rules.

At 844, the SMF 814 selects an appropriate UPF from the relevant S-NSSAI the UPF is associated to, for example, according to temporal validity and spatial validity conditions and establishes connectivity resources. In embodiments, this NAS message may indicate how traffic categories are mapped to specific route selection descriptors, including time and spatial validity condition, for example, on per tracking area or cell level.

In embodiments, if the SMF 814 cannot accept the data connectivity request from the WTRU, due to unavailability of resources, services for the requested traffic category/DNN, then it may send a rejection to the WTRU. In embodiments, this may be a dedicated rejection message, or a rejection indication provided in the data connectivity response message. When the rejection message or indication is sent, an appropriate cause value is provided so the WTRU may take the following actions based on the cause value: for example back off, hold the traffic an attempt again after a set timer, or update the registration.

At 846, the WTRU 812 provides appropriate socket information to the application 810.

With reference to FIG. 8, in embodiments of network slice-free procedures to request data connectivity resources, a WTRU performs the following steps.

At 820 the WTRU sends a NAS message to the network. The message indicates to the network the WTRU capabilities related to services the WTRU hardware supports, for example, whether the WTRU supports IMS calling, streaming services or IoT traffic and a service module profile, indicating the cellular features the WTRU supports, possibly through a software module map. This NAS message may be sent to a NF, for example, RMF 813 or any other NF, and the NAS layer parameter may indicate a service capability and/or a service function module. The message may indicate the characteristics or capabilities of the WTRU 812 in terms of terms of cellular features of functionality the WTRU support, for example, whether the WTRU supports high data rates, IMS voice, satellite communication and the like. The WTRU also provides a service module indicating service logic. In embodiments, the WTRU may support, for example, whether the WTRU is capable of supporting time sensitive communications, or artificial intelligence markup language (AIML)-based cellular functional logic (for example, PLMN selection) and the like.

At 832, the WTRU receives a NAS message from the NF, for example from the RMF 813 or any other network function the WTRU may have contacted at 820, for example, a LMF, a PCF or an NSSF, if the WTRU supports direct connection via SBA functionality. If this message is a response to a registration request, the WTRU may also receive a temporary address (possibly with a validity timer) of the SMF the WTRU should use to establish data connectivity. The WTRU may initialize a timer based on this information. The WTRU may trigger a registration procedure upon expiration of this timer. In embodiments, the NAS message may be received from registration management function, and the NAS layer parameter may indicate a service configuration update. In embodiments, the NAS message may indicate, if this message is a response to a registration request, that the message may contain a temporary address (possibly with a validity timer) of the SMF the WTRU should use to establish data connectivity.

In embodiments of network slice-free procedures to request data connectivity resources, an RMF 813 performs the following steps.

At 820, the RMF 813 receives the NAS message from the WTRU. The NAS layer parameter may indicate a service capability or a service function module.

At 822, the RMF 813 sends a message to the UDR/UDM 816. The message indicates WTRU capabilities related to services the WTRU hardware supports.

At 824, the RMF 813 receives a message from the UDR/UDM 816 indicating the S-NSSAI(s) associated with the WTRU's service capability or a service function module. It may also receive from UDR/UDM an allowed (i.e., a subset/or replacement of) service capability or a service function module. For roaming cases, the RMF does not receive the S-NSSAI, only the allowed (i.e., a subset/or replacement of) service capability or a service function module, as described at 826, the V-RMF deriver local (i.e., visited PLMN specific) network slices.

At 828 the RMF 813 sends a message to the NSSF 817 indicating the S-NSSAI(s) associated with the WTRU's service capabilities received at 820. The message requests from the NSSF to select an SMF based on the provided S-NSSAI. Alternatively, this message may be sent to Network Repository Function (NRF), using the WTRU's service capabilities as part of the NF (SMF) profile.

At 830, the RMF 813 receives from the NSSF 817 (or NRF) the SMF ID or SMF instance ID of the SMF associated to the WTRU service/service module capabilities provided at 820.

At 832, the RMF 813 generates a temporary SMF identifier and sends a temporary SMF ID and configuration update, for example, allowed services and, in embodiments, temporal and spatial validity restrictions/conditions for these services to the WTRU.

In embodiments of network slice-free procedures to request data connectivity resources, an SMF 814 performs the following steps.

At 838, the SMF receives a NAS message from the WTRU 812. The message indicates to the network requested traffic categories and DNN.

In embodiments for network slice-free procedures to request data connectivity resources, a WTRU performs the following steps with reference to FIG. 8.

At 834, the WTRU receives a connection management application message from an application 810, requesting data connectivity. The message may indicate an application identifier, operating system ID and possibly the required connectivity services the application needs, for example: time sensitive communication, IMS calling, satellite calling, video streaming and the like. This message may be received from a terminal equipment component inside the WTRU terminal. In embodiments, this message may be an AT command, or a message implemented through a vendor specific connection manager.

At 836, the WTRU 812 derives traffic categories and associated DNN, and it may also select a service module ID that can serve this combination.

At 838, the WTRU 812 sends a NAS message to the network. The message indicates to the network a that data connectivity, supporting certain traffic categories in a specific data network is required. In embodiments, this NAS message may indicate whether traffic categories need network support on the entire registration area or just on certain locations at certain times. In embodiments, this NAS message may indicate a request to update traffic categories, for example, using a supporting URSP rule enforcement indication

At 844, the WTRU 812 receives a NAS message from the network (for example, from the SMF 814) indicating whether the data connectivity request is granted and if so how it is granted. In embodiments, the NAS message may indicate what traffic categories can be satisfied by the network. In embodiments, the NAS message may indicate whether traffic categories can be supported on the entire registration area or just on certain locations at certain times. In embodiments, this NAS message may indicate as part of the URSP rules, how traffic categories (mapped to connection capabilities) should be supported according to the mapped route selection descriptor.

At 846, the WTRU 812 sends a connection management message to the application 810 (for example, using an AT command) indicating whether the data connectivity request is granted, and possibly what services can be provided in by the current network when and at what locations. The AT command may include parameter, for example, IP address, and available traffic categories that the network is willing to support.

In embodiments for network slice-free procedures to request data connectivity resources, with reference to FIG. 8 an SMF 814 performs the following steps.

At 838, the SMF 814 receives from the WTRU 8123 a NAS message indicating a request for data connectivity. The NAS message indicates the requested traffic categories and DNN combinations. This NAS message may indicate whether traffic categories need network support on the entire registration area or just on certain locations at certain times. This NAS message may indicate a request to update traffic categories, for example, using a supporting URSP rule enforcement indication.

At 840, the SMF 814 sends to the PCF 815 a message requesting policies regarding network support for a given traffic categories and DNN combinations. This message may indicate the traffic categories and DNN combinations requested by the WTRU. This NAS message may indicate whether the requested traffic categories and DNN combinations can be served in the entire RA and during the entire time the WTRU is registered in the RA or only a specific time.

At 842, the SMF 814 receives from the 815 PCF a message providing the URSP rules the PCF has selected for the specific WTRU and requested traffic categories/DNN combinations. This NAS message may indicate the policies that governed how traffic categories are mapped to specific route selection descriptors, including time and spatial validity condition, for example, on per tracking area or even cell level.

AT 844, the SMF 814 a NAS message to the WTRU 812 indicating whether the data connectivity granted. This NAS message may indicate how traffic categories are mapped to specific route selection descriptors, including time and spatial validity condition, for example, on per tracking area or even cell level.

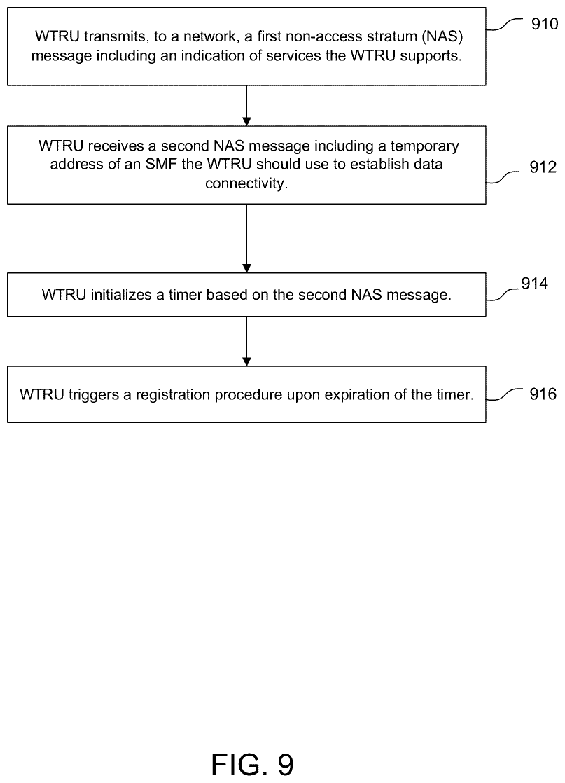

FIG. 9 is a flow diagram of an example process performed by a WTRU. At 910, the WTRU transmits, to a network, a first non-access stratum (NAS) message including an indication of services the WTRU supports. At 912, the WTRU receives a second NAS message including a temporary address of an SMF the WTRU should use to establish data connectivity. At 914, the WTRU initializes a timer based on the second NAS message. At 916, the WTRU triggers a registration procedure upon expiration of the timer.

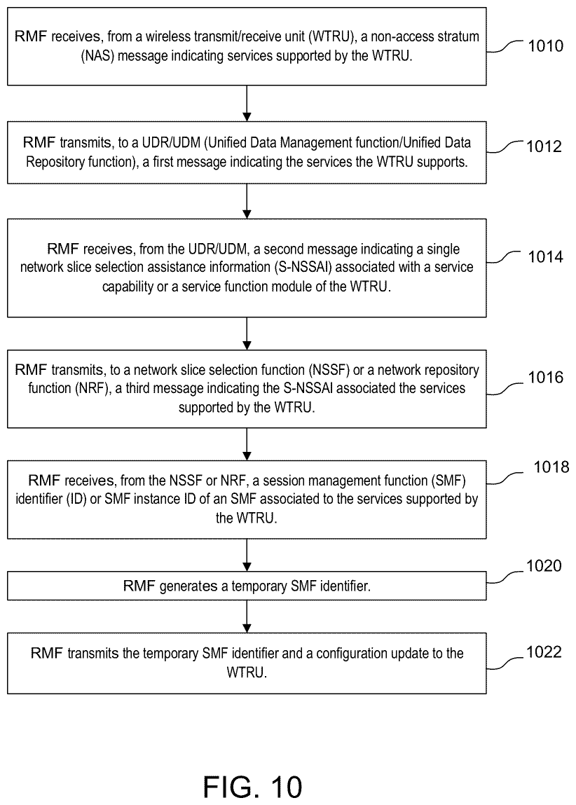

FIG. 10 is a flow diagram of an example process performed by an RMF. At 1010, the RMF receives, from a wireless transmit/receive unit (WTRU), a non-access stratum (NAS) message indicating services supported by the WTRU. At 1012, the RMF transmits, to a UDR/UDM (Unified Data Management function/Unified Data Repository function), a first message indicating the services the WTRU supports. At 1014, the RMF receives, from the UDR/UDM, a second message indicating a single network slice selection assistance information (S-NSSAI) associated with a service capability or a service function module of the WTRU. At 1016, the RMF transmits, to a network slice selection function (NSSF) or a network repository function (NRF), a third message indicating the S-NSSAI associated the services supported by the WTRU. At 1018, the RMF receives, from the NSSF or NRF, a session management function (SMF) identifier (ID) or SMF instance ID of an SMF associated to the services supported by the WTRU. At 1020, the RMF generates a temporary SMF identifier. At 1022, the RMF transmits the temporary SMF identifier and a configuration update to the WTRU.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method performed by a wireless transmit/receive unit (WTRU), comprising:
transmitting, to a network, a first non-access stratum (NAS) message including an indication of services the WTRU supports;
receiving a second NAS message including a temporary address of an SMF the WTRU should use to establish data connectivity;
initializing a timer based on the second NAS message; and
triggering a registration procedure upon expiration of the timer.

2. The method of claim 1, wherein the first NAS message includes an indication that the WTRU supports including at least one of IP multimedia core network subsystem (IMS) calling, streaming services or internet of things (IoT) traffic; and a service module profile, indicating cellular features the WTRU supports.

3. The method of claim 1, wherein the first NAS message includes an indication that the WTRU supports time sensitive communications, or artificial intelligence markup language (AIML)-based cellular functional logic.

4. The method of claim 1, wherein the registration procedure includes:
transmitting, to the network, a third NAS message including a data connectivity request and indicating that support for traffic categories in a specific data network is required; and
receiving, from the network, a fourth NAS message indicating whether the data connectivity request is granted.

5. The method of claim 4, wherein the third NAS message includes an indication that the traffic categories either require network support on an entire registration area or require network support on predetermined locations at predetermined times.

6. The method of claim 4, wherein the fourth NAS message includes an indication that the traffic categories are supported on an entire registration area or require network on predetermined locations at predetermined times.

7. The method of claim 4, wherein the fourth NAS message includes an indication that the traffic categories are supported according to a mapped route selection descriptor.

8. A method for use in a resource management facility (RMF) in a cellular network, the method comprising:
receiving, from a wireless transmit/receive unit (WTRU), a non-access stratum (NAS) message indicating services supported by the WTRU;
transmitting, to a UDR/UDM (Unified Data Management function/Unified Data Repository function), a first message indicating the services the WTRU supports;
receiving, from the UDR/UDM, a second message indicating a single network slice selection assistance information (S-NSSAI) associated with a service capability or a service function module of the WTRU;
transmitting, to a network slice selection function (NSSF) or a network repository function (NRF), a third message indicating the S-NSSAI associated the services supported by the WTRU;
receiving, from the NSSF or NRF, a session management function (SMF) identifier (ID) or SMF instance ID of an SMF associated to the services supported by the WTRU;
generating a temporary SMF identifier; and
transmitting the temporary SMF identifier and a configuration update to the WTRU.

9. The method of claim 8, wherein the configuration update includes an indication of allowed services and temporal and spatial validity restrictions.

10. The method of claim 8, wherein the configuration update includes an indication of allowed services and conditions for the allowed services.

11. The method of claim 8, wherein the first NAS message includes an indication that the WTRU supports: IP multimedia core network subsystem (IMS) calling, streaming services or internet of things (IoT) traffic; and a service module profile, indicating cellular features the WTRU is capable of supporting.

12. The method of claim 8, wherein the first message indicates a service capability or a service function module.

13. The method of claim 8, wherein the temporary SMF identifier is valid within a registration area allocated to the WTRU.

14. The method of claim 8, wherein the temporary SMF identifier is valid within a specific area of service.

15. The method of claim 8, further comprising transmitting a validity time for the temporary SMF identifier to a base station.

16. A wireless transmit receive unit (WTRU) comprising:
a processor and
a transceiver, wherein the processor and the transceiver are configured to:
transmit, to a network, a first non-access stratum (NAS) message including an indication of services the WTRU supports;
receive a second NAS message including a temporary address of an SMF the WTRU should use to establish data connectivity;
initialize a timer based on the second NAS message; and
trigger a registration procedure upon expiration of the timer.

17. The WTRU of claim 16, wherein the first NAS message includes an indication that the WTRU supports at least one of: IP multimedia core network subsystem (IMS) calling, streaming services or internet of things (IoT) traffic; and a service module profile, indicating cellular features the WTRU supporting supports.

18. The WTRU of claim 16, wherein the first NAS message includes an indication that the WTRU supports time sensitive communications, or artificial intelligence markup language (AIML)-based cellular functional logic.

19. The WTRU of claim 16, wherein the registration procedure includes:
transmitting, to the network, a third NAS message including a data connectivity request and indicating that support for traffic categories in a specific data network is required; and
receiving, from the network, a fourth NAS message indicating whether the data connectivity request is granted.

20. The WTRU of claim 19, wherein the third NAS message includes an indication that the traffic categories either require network support on an entire registration area or require network support on predetermined locations at predetermined times.
